(19) United States
(12) Patent Application Publication
(10) Pub. No.: US 2003/0126689 A1
(43) Pub. Date: Jul. 10, 2003

(54) Process for providing improved whiteness to fabric and for removing formaldehyde and formaldehyde conjugates from treated fabric

(75) Inventors: Victor Manuel Arredondo, West Chester, OH (US); Mohan Rao, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/310,012

(22) Filed: Dec. 4, 2002

Related U.S. Application Data
(60) Provisional application No. 60/340,892, filed on Dec. 7, 2001.

(51) Int. Cl. C11D 3/00; C11D 7/54; C11D 7/18; C11D 9/42

(52) U.S. Cl. 8/115.51; 510/302

(57) ABSTRACT

The present invention relates to a process for providing improved whiteness to cellulosic fabric comprising the steps of:

a) contacting cellulosic fabric with a composition comprising:

i) from about 0.05% to about 0.5% by weight, of hydrogen peroxide or a source of hydrogen peroxide;

ii) from 0.01% to about 10% by weight, of a base or other source of alkalinity;

iii) from about 0.001% to about 0.5% by weight, of a bleach stabilizer; and

iv) the balance carriers and other adjunct ingredients:

wherein the composition has a pH of from about 7 to about 12; at a temperature from about 50° C. to about 80° C. for a period of time from about 5 minutes to about 60 minutes to form a treated fabric; and

b) rinsing the treated fabric with a second composition comprising:

i) water; and

ii) optionally rinse aids and other adjunct ingredients;

to provide a finished fabric.

### CROSS REFERENCE TO RELATED APPLICATIONS

This application claims priority under 35 U.S.C. §119(e) to U.S. Provisional Application Serial No. 60/340,892, filed Dec. 7, 2001 (Attorney Docket No. 8802P).

### FIELD OF THE INVENTION

The present invention relates to a process for removing residual formaldehyde and formaldehyde conjugates from fabric which has been treated with formaldehyde. The process produces a fabric having less than 75 ppm formaldehyde as free formaldehyde or in the form of formaldehyde conjugates, dimers, oligomers, polymers, and the like. The present invention further relates to a process for providing enhanced whiteness to cellulosic fabric or fabric which comprises cellulosic fabric. The present process also provides a means for removing residual formaldehyde from fabric which has been treated in a prior fabric treatment step with formaldehyde.

### BACKGROUND OF THE INVENTION

Cellulosic fiber, cotton, inter alia, has been used since antiquity to form fabric which is used to produce articles of manufacture ranging from draperies and wearing apparel to bandages and the coverings for furniture. Among the many uses of cellulosic fabric, clothing is, perhaps, most ubiquitous.

Manufacturers of cellulosic fabric comprising clothing have sought to modify the fibers themselves, as well as the bulk fabric. Modifications include dyeing to produce colored fabric, processing to produce fabric having a softer feel, water repellency, and the like. Due to the nature of cellulosic fabric its structure and shape are dependent on the circumstances under which formation of intermolecular and intramolecular hydrogen bonding occurs. Wrinkling, which is related to the forming of these hydrogen bonds, has been a problem manufacturers have sought to overcome in order to provide the consumer with a carefree article of clothing. For example, cellulosic fibers have been treated in a manner which produces a fabric which resists the wrinkling typical of non-treated fabric.

A common form of treatment is to expose cellulosic fabric to formaldehyde, typically in the presence of a catalyst, to provide crosslinking of the cellulose units and thereby producing an article of clothing which holds its shape when exposed to water or when laundered. However, the present processes do not successfully remove all residual formaldehyde.

Although fabric has been dyed since antiquity to provide a colored aesthetic option, white fabric itself is not the result of a lack of dyeing. To achieve a white fabric, especially cellulosic and cellulose comprising fabric, the fabric must be treated to remove the natural color bodies and the colors which are formed during the various processing steps. In general, durable press treatments, including formaldehyde treatments, impart a “yellow cast” which detracts from the aesthetic appearance of the fabric.

When coupled with a formaldehyde treatment, the fabric will have a “yellow cast” which detracts from the aesthetic appearance of the fabric. Present processes do not provide a means for removing formaldehyde to a level at or below 75 ppm while providing an enhanced whiteness to fabric.

There is therefore a long felt need for a post formaldehyde treatment process which is capable of removing residual formaldehyde and formaldehyde conjugates wherein the final fabric has a sustained level of formaldehyde of 75 ppm or less. There is also a need for a process which provides white fabric treated with formaldehyde with a white, bright appearance.

### SUMMARY OF THE INVENTION

The present invention meets the aforementioned needs in that it has been surprisingly discovered that residual formaldehyde is present on fabric not only as free formaldehyde, but also in the form of formaldehyde conjugates, inter alia, as paraformaldehyde. In addition, it has also been surprisingly discovered that many treatments used by formulators and manufacturers to remove or reduce the amount of formaldehyde, are reversible processes which lead to inaccurate formaldehyde testing results. In addition, it has been surprisingly found that these chemical species which participate in these reversible processes remain on fabric and result in fabric having higher than certified formaldehyde levels when purchased by the consumer.

Once these surprising circumstances were realized, a solution to the problem was developed. The first aspect of the present invention relates to the understanding that formaldehyde is present on formaldehyde treated fabric in many forms and that the present process removes not only free formaldehyde, but formaldehyde conjugates, and the like, said process comprising the steps of:

a) contacting fabric which contains formaldehyde with a solution comprising:

i) from about 0.01% to about 10% by weight, of a base or other source of alkalinity;

ii) optionally, from 0.01% to about 10% by weight, of a wetting agent; and

iii) the balance carriers or other adjunct ingredients;

at a temperature of from about 35° C. to about 95° C. to produce an alkaline treated fabric; and

b) rinsing said alkaline treated fabric with water to produce a treated fabric, said fabric having less than about 75 ppm formaldehyde.

Another aspect of the present invention relates to a process for providing improved whiteness to cellulosic fabric comprising the steps of:

a) contacting cellulosic fabric with a composition comprising:

i) from about 0.05% to about 0.5% by weight, of hydrogen peroxide or a source of hydrogen peroxide;

ii) from 0.01% to about 10% by weight, of a base or other source of alkalinity;

iii) from about 0.001% to about 0.5% by weight, of a bleach stabilizer; and

iv) the balance carriers and other adjunct ingredients:

wherein said composition has a pH of from about 7 to about 12; at a temperature from about 50° C. to about 80° C. for a period of time from about 5 minutes to about 60 minutes to form a treated fabric; and

b) rinsing said treated fabric with a second composition comprising:

i) water; and

ii) optionally rinse aids and other adjunct ingredients;

to provide a finished fabric.

A yet further aspect of the present invention relates to rinsing said treated fabric in a counter current bath wherein the amount of formaldehyde in all forms is reduced to less than 75 ppm formaldehyde.

These and other objects, features, and advantages will become apparent to those of ordinary skill in the art from a reading of the following detailed description and the appended claims. All percentages, ratios and proportions herein are by weight, unless otherwise specified. All temperatures are in degrees Celsius (° C.) unless otherwise specified. All documents cited are in relevant part, incorporated herein by reference.

### DETAILED DESCRIPTION OF THE INVENTION

The present invention relates to treatment of cellulosic fabric after said fabric has been treated with formaldehyde. The process of the present invention reduces the level of formaldehyde to less than 75 ppm both immediately after processing, as well as after the fabric has been converted into an article of manufacture and provided to the consumer.

Water washing has been known to remove residual formaldehyde, however, the amount of water, the rinse time, and the temperature at which the water must be maintained make this route wholly impractical.

There has been a long felt need to reduce the amount of residual formaldehyde present on cellulosic fabric which has been processed with formaldehyde typically to imbue said fabric with permanent press benefits. However, until the present invention, it was not well understood that formaldehyde not used to cross link fibers, was forming other conjugates or formaldehyde releasing species. These species include dimers, trimers, formaldehyde oligomers and the like (for example, paraformaldehyde), as well as cellulosic hydroxyls having a releasable formaldehyde unit.

Manufacturers of treated cellulosic fabric typically wash the fabric in water until the measured level of formaldehyde is below about 200 ppm. For children's clothing the level of permitted formaldehyde is even lower. The amount of formaldehyde on clothing is closely regulated by law, including Japanese Law which has established 75 ppm as the maximal level of formaldehyde which is allowed on clothing. Described herein, the Japanese Law formaldehyde test is used to measure the level of formaldehyde on clothing treated by the present process. Also, clothing which has initially passed testing levels but which subsequently have higher levels are also evaluated by this test.

As part of the present invention, it was surprisingly discovered that certain formaldehyde removing processes or reagent used to scavenge formaldehyde, only act form species which mask the presence of formaldehyde and thereby frustrate the accuracy of formaldehyde determination test procedures. It has become clear in our hands that these species remain on fabric and subsequently release the bound formaldehyde at a later time thereby producing higher than desirable formaldehyde levels on fabric. It has also been discovered that excess formaldehyde can complex into chemical species which are non-reactive to formaldehyde test methods but also breakdown subsequent to the fabric being formed into clothing.

For the purposes of the present invention the term “formaldehyde conjugate” is defined herein as “any species or form of formaldehyde which is capable of releasing formaldehyde once the fabric is utilized after the manufacturing process.”

For the purposes of the present invention the term “formaldehyde scavengers” is defined herein as “any chemical entity which is employed to remove or scavenge residual formaldehyde but which is capable of re-releasing the removed or scavenged formaldehyde.”

### Process

The first aspect of the present invention relates to removal of formaldehyde from cellulosic or cellulose-containing fabric which is dyed, colored, and/or white.

Step (a) of the process which relates to the first aspect of the present invention encompasses contacting fabric with a formaldehyde removing solution. The fabric treated in this process has been exposed to formaldehyde or contains residual formaldehyde from a previous process or step, for example, a permanent press treatment step. Step (a) comprises the step of contacting the treated fabric with a solution comprising:

i) from about 0.01% to about 10%, in another embodiment with a solution comprising from about 0.05% to about 5%, while a further embodiment comprises from about 0.1% to about 1% by weight, of a base; one embodiment of the present invention utilizes 0.5% by weight, of said base. The amount of base present must also provide a solution pH of from about 7.5 to about 14, however, one embodiment of the present invention requires a pH range of from about 8 to about 9.5 while another embodiment of this aspect relates to solutions having a pH of from about 8.5 to about 9. Yet another embodiment employs as solution having an average pH from about 8 to about 9.

Any base or source of alkalinity may be used in forming the solution of step (a). One embodiment of this aspect of the present invention relates to bases selected from the group consisting of alkali metal, alkali earth metal, ammonium, and alkyl ammonium hydroxides, hydrogen carbonates, carbonates, phosphates, hydrogen phosphates, dihydrogen phosphates, and mixtures thereof. These bases include sodium hydroxide, sodium carbonate, sodium bicarbonate, sodium phosphate, sodium hydrogen phosphate, sodium dihydrogen phosphate, potassium hydroxide, potassium carbonate, potassium bicarbonate, potassium phosphate, potassium hydrogen phosphate, potassium dihydrogen phosphate, lithium hydroxide, lithium carbonate, lithium bicarbonate, lithium phosphate, lithium hydrogen phosphate, lithium dihydrogen phosphate, calcium hydroxide, calcium carbonate, calcium bicarbonate, calcium phosphate, calcium hydrogen phosphate, magnesium hydroxide, magnesium carbonate, magnesium bicarbonate, magnesium phosphate, magnesium hydrogen phosphate, ammonium hydroxide, ammonium carbonate, ammonium bicarbonate, ammonium phosphate, ammonium hydrogen phosphate, ammonium dihydrogen phosphate, and the like.

The amount of time and the temperature at which the fabric is exposed to step (a) is critical and predicated on several factors including the final level of residual formaldehyde desired, the amount of formaldehyde used to initially treat the fabric, whether the process of the present invention is to be accomplished by way of a continuous process or a batch process. One embodiment of the procedure of the present invention utilizes a temperature of from about 35° C. to about 95° C. One embodiment of this aspect treats the fabric in a solution at a temperature of about 65° C.

Depending upon other factors, the time during which the fabric treated in step (a) is held in contact with said solution is from 1 minute to about 90 minutes. One embodiment of the present invention which utilizes a 0.5% NaHCO₃ solution at a temperature of 65° C., contacts the fabric with the solution of step (a) for 10 minutes.

The solution into which is contacted the fabric treated in step (a) of the present invention further comprises:

ii) optionally, from 0.01% to about 10% by weight, of a wetting agent. One embodiment of the present process utilizes from about 0.05% to about 5% by weight, of a wetting agent, while other embodiments comprise from about 0.1% to about 1%, of said wetting agent. One specific example of the present invention utilizes a bath which comprises 0.5% by weight, of a wetting agent.

One embodiment of this aspect of the present invention utilizes a wetting agent having the formula:

R(OR¹)ₓ(OCH₂CHOHCH₂)_{y}OR²

wherein R and R² are each independently selected from hydrogen, C₁-C₂₂ alkyl, and mixtures thereof; each R¹ is independently C₂-C₆ alkylene, and mixtures thereof; the index x has the average value of from 0.1 to about 50; the index y is 0 or 1.

Non-limiting examples of wetting agents include Tergitol® 15-S-3, Tergitol® 15-S-5, Tergitol® 15-S-7, Tergitole 255-L-3 ex Union Carbide, Neodol® 25-3S ex Shell Oil Co.

iii) the balance of the solution utilized in step (a) of the present process comprises carriers or other adjunct ingredients. Typically the carrier is water, however, co-solvents which are compatible with the process of the present invention can also be used.

The fabric after being contacted with the solution of step (a) under the conditions of step (a) is referred to herein as an alkaline treated fabric. Therefore, step (a) of the present invention produces an alkaline treated fabric.

Step (b) of the process of the present invention relates to rinsing said alkaline treated fabric produced in step (a) with water to produce a treated fabric, said fabric having less than about 75 ppm formaldehyde.

The method for rinsing may be immersion in a single bath or as one embodiment of the present invention provides, the rinsing can be done in a series of counter current baths.

The treated fabric will have less than 300 ppm as determined by the MTCC Test Method 144-1997 (Alkali in Wet Processed Textiles: Total) and less than about 75 ppm formaldehyde as measured by either the JIS L 1041 described herein below.

The second aspect of the present invention relates to removal of formaldehyde from white fabric and further enhancement of the white color and brightness thereof.

Step (a) of the process relating to the second aspect of the present invention to contacting non-dyed or white fabric which contains residual formaldehyde from a previous process or step which involves contacting said fabric with formaldehyde, with a solution comprising:

i) from about 0.05% to about 2% by weight, of hydrogen peroxide or a source of hydrogen peroxide. Another embodiment of this aspect comprises from about 0.1% to about 1% by weight of hydrogen peroxide or a source thereof. However, the range of hydrogen peroxide in one useful embodiment is from 0.1% to about 0.5% by weigh of hydrogen peroxide or a source thereof.

When a source of hydrogen peroxide is used in step (a) of this aspect, one embodiment utilizes sources selected from the group consisting of perborate, percarbonate, and mixtures thereof. Suitable for use are sodium perborate, sodium perborate monohyd rate, sodium perborate tetrahyd rate, sodium percarbonate, and the like.

ii) from about 0.01% to about 10%, in another embodiment with a solution comprising from about 0.05% to about 5%, while a further embodiment comprises from about 0.1% to about 1% by weight, of a base; one embodiment of the present invention utilizes 0.5% by weight, of said base. The amount of base present must also provide a solution pH of from about 7 to about 12, however, on embodiment of the present invention requires a pH range of from about 8 to about 9. The bases which are suitable for use in this aspect of the present invention are the same as described hereinabove.

iii) from about 0.001% to about 2% by weight, of a bleach stabilizer. One embodiment relates to the use of sodium silicate as a bleach stabilizer. Another embodiment relates to the used of organic bleach stabilizers selected from the group consisting of hydroxycarboxylates, amino carboxylates, organophosphonates, and mixtures thereof. A first class of organic stabilizers is the hydroxycarboxylate stabilizers, for example, gluconic acid, glucoheptonic acid, or mixtures thereof. A second class of organic stabilizers is the amino carboxylate stabilizers, for example, nitrilotriacetic acid, ethylenediamine-tetraacetic acid, diethylenetriaminepentaacetic acid, or mixtures thereof. A third class of suitable organic stabilizers is the organophosphonate stabilizers, for example, aminotri (methylenephosphonic acid), 1-hydroxethylidene-1,1-diphosphonic acid, ethylenediaminetetra (methylenephosphonic acid), diethylenetriaminepenta (methylenephosphonic acid), and mixtures thereof.

iv) The balance of the compositions which comprise step (a) of this aspect are carriers and other adjunct ingredients.

The amount of time and the temperature at which the fabric is exposed to step (a) is critical and predicated on several factors including the amount of residual formaldehyde desired, the amount of formaldehyde used to initially treat the fabric, whether the process of the present invention is to be accomplished by way of a continuous process or a batch process. One aspect of the present invention utilizes a temperature of from about 50° C. to about 80° C. One embodiment of this aspect treats the fabric in a solution at a temperature of from about 60° C. to about 65° C.

Depending upon other factors, the time during which the fabric treated in step (a) is held in contact with said solution is from 5 minutes to about 60 minutes. One embodiment of the present invention utilizes a solution comprising:

i) 0.5% by weight, of hydrogen peroxide;

ii) 5% by weight, of NaHCO₃;

iii) 0.5% by weight, of sodium silicate; and

iv) water as a carrier;

at a solution pH of 8.5, at a temperature of 65° C., contacts the fabric with said solution for from 15 to 25 minutes. In fact, the contact time of 15 to 25 minutes is suitable for many solution embodiments of step (a)

In a highly effective embodiment of this aspect, from about 0.01% to about 3% by weight, of an optical brightener is added as an optional ingredient. For the purposes of the present invention the terms “optical brighteners” and “fluorescent whiteners” are use interchangeably and are taken to mean organic compounds which absorb the invisible ultraviolet (UV) portion of the daylight spectrum and convert this energy into the longer-wavelength visible position of the spectra.

Other embodiments comprise from about 0.1% to about 2.5%, while another comprises from about 0.01% to about 2% by weight, of one or more optical brighteners

The following are non-limiting examples of fluorescent whitener agents suitable for use in the present invention.

a) Distyryl-biphenyl (DSBP) optical brighteners which can be mono- or polysulfonated, said DSBP brighteners having the formula:

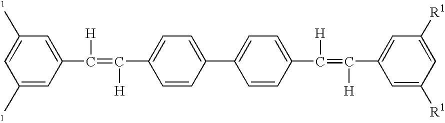

wherein each R¹ is independently hydrogen, —SO₃M, —CN, Cl, OCH₃, —C(O)OCH₃, —SO₂N(R²)₂, —C(O)N(R²)₂, and mixtures thereof; wherein each R² is independently C₁-C₈ alkyl, M is hydrogen or a salt forming cation, for example, sodium, potassium, lithium, and mixtures thereof; provided at least one R¹ units is a —SO₃M units wherein M is a salt forming cation. Non-limiting examples of DSBP optical brighteners include Tinopal CBS-X® available ex Ciba-Geigy.

b) Triazinyl stilbene optical brighteners which can be mono- or polysulfonated, said triazinyl brighteners having the formula:

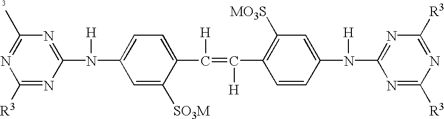

wherein each R³ is independently selected from the group consisting of:

i) phenyl amino having the formula:

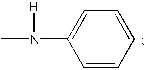

ii) sulphonyl substituted phenyl amino having the formula:

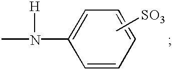

iii) di-sulphonyl substituted phenyl amino having the formula:

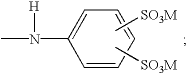

iv) carboxy substituted phenyl amino having the formula:

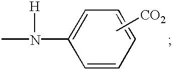

v) morpholinyl having the formula:

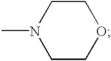

vi) alkylenemethoxy amino having the formula:

—NH(CH₂)₂₋₃OCH;

vii) 2-hydroxyethylamino;

viii) di-(2-hydroxyethyl)amino;

ix) chloro;

x) hydrogen;

xi) amino;

xii) methoxy;

xiii) alkylenesulphonyl amino;

xiv) —NHR⁴;

xv) —N(R⁴)₂;

wherein each R⁴ is independently C₁-C₈ alkyl, M is hydrogen or a salt forming cation, for example, sodium, potassium, lithium, and mixtures thereof. Non-limiting examples of triazinyl stilbene optical brighteners include Tinopal 5-BMX® available ex Ciba-Geigy. See U.S. Pat. No. 3,954,740 Fringeli, issued May 4, 1976 incorporated herein by reference.

c) triazolyl stilbenes optical brighteners which can be mono- or polysulfonated, said triazolyl brighteners having the formula:

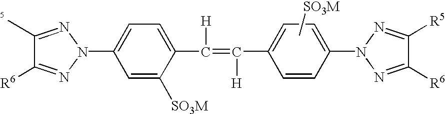

wherein each R⁵ and R⁶ is independently selected form the group consisting of hydrogen, chlorine, —NHCH₃, —N(CH₃)₂, —SO₃M, —SO₃NH₂, —SO₃N(R⁷)₂, —SO₃C₆H₅, —OCH₃, —CN, —CON(R⁷)₂, and mixtures thereof; each R⁷ is independently C₁-C₈ alkyl, M is hydrogen or a salt forming cation, preferably sodium, potassium, lithium, and mixtures thereof. Non-limiting examples of triazinyl stilbene optical brighteners include Blankophor BHC® available ex Mobay.

d) naphthotriazolyl stilbenes optical brighteners which can be mono- or polysulfonated, said naphthotriazolyl brighteners having the formula:

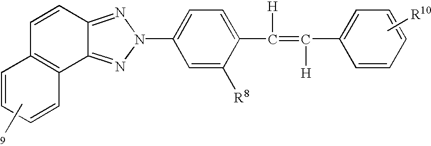

wherein R⁸ is selected from the group consisting of hydrogen, —SO₃H, —SO₃NH₂, —SO₃C₆H₅, —CN, and mixtures thereof; R⁹ is selected from the group consisting of hydrogen, —SO₃M, —CN, chlorine, —OCH₃, —NHCH₃, —N(R¹¹)₂, —SO₃NH₂, —SO₃C₆H₅, —SO₃N(R¹¹)₂, —CO₂CH₃, —CON(R¹¹)₂, and mixtures thereof; R¹⁰ is selected from the group consisting of hydrogen, —SO₃H, —OCH₃, and mixtures thereof; each R¹¹ is independently C₁-C₈ alkyl, M is hydrogen or a salt forming cation, for example, sodium, potassium, lithium, and mixtures thereof; provided at least one R⁸, R⁹, or R¹⁰ is —SO₃M. Non-limiting examples of naphthotriazolyl stilbenes optical brighteners includes Tinopal RBS® ex Ciba-Geigy.

e) Diarylpyrazolines having the formula:

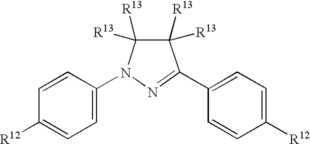

wherein each R¹² is independently hydrogen, —SO₃M, —CN, chlorine, —OCH₃, —NHCH₃, —N(R¹⁴)₂, —SO₃NH₂, —SO₃C₆H₅, —SO₃N(R¹⁴)₂, —CO₂CH₃, —CON(R¹⁴)₂, and mixtures thereof; each R¹³ is independently hydrogen, C₁-C₈ alkyl, aryl, and mixtures thereof. Several embodiments include aryl units which are substituted and unsubstituted phenyl, biphenyl, naphthyl, said substitution is selected form the group consisting of —SO₃M, —CN, chlorine, —OCH₃, —NHCH₃, —N(R¹⁴)₂, —SO₃NH₂, —SO₃C₆H₅, —SO₃N(R¹⁴)₂, —CO₂CH₃, —CON(R¹⁴)₂, and mixtures thereof; each R¹⁴ is independently C₁-C₈ alkyl, M is hydrogen or a salt forming cation, for example sodium, potassium, lithium, and mixtures thereof. See U.S. Pat. No. 3,962,116 Bloching et al., issued Jun. 8, 1976 incorporated herein by reference.

f) Coumarins having the formula:

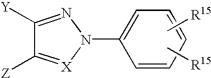

wherein each R¹⁵ is independently hydrogen, halogen, C₁-C₄ alkyl, C₁-C₄ alkylsulphonate, C₁-C₄ alkoxy, and mixtures thereof; X is nitrogen or —CH═; Y is hydrogen, chlorine, methyl, and mixtures thereof; Z is a coumarin comprising radical having the formula:

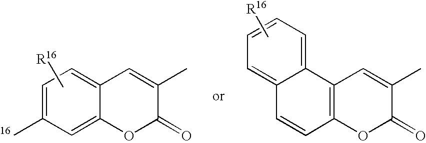

wherein each R¹⁶ is independently C₁-C₁₂ alkoxy, C₂-C₂ alkenyloxy, benzyloxy, said benzyloxy optionally substituted with halogen, methyl, methoxy, and mixtures thereof. For a further description of coumarins which are suitable for use as optical brighteners in the present invention see U.S. Pat. No. 3,966,755 Schlapfer, issued Jun. 29, 1976.

In addition, see U.S. Pat. No. 3,646,015 Hamilton, issued Feb. 29, 1972 and U.S. Pat. No. 4,483,780 Llenado, issued Nov. 20, 1984 both of which are incorporated herein by reference.

Step (b) of this aspect of the process of the present invention relates to rinsing said alkaline treated fabric produced in step (a) with water to produce a treated fabric, said fabric having less than about 75 ppm formaldehyde.

Another aspect of the present invention relates to a process wherein the solution of step (a) for both the first and second aspects described herein above are applied to said formaldehyde containing fabric with a roller or pad. Step (b) of this third aspect relates to exposing said treated fabric to an atmospheric steam chamber which removes the treatment solution and residual formaldehyde.

As it relates to this aspect, one embodiment comprises a solution applied in step (a) having 10% by weight, of sodium hydrogen carbonate as the source of alkalinity.

The fabric is exposed to an atmospheric steam chamber in step (b) wherein said chamber is held at a temperature of from about 90° C. to about 100° C., wherein one embodiment maintains the chamber temperature as constant as possible just below 100° C.

The fabric can be held in the steam chamber from 1 minute to about 10 minutes, one embodiment utilizing a 10% solution of sodium hydrogen carbonate exposes said fabric for about 5 minutes. One embodiment of this aspect utilizes a solution pH of from about 8 to about 9 when applying the solution of step (a) and removing the residual formaldehyde via a steam chamber.

The method for rinsing may be immersion in a single bath or as one embodiment of the present invention provides, the rinsing can be done in a series of counter current baths.

The treated fabric will have less than 300 ppm as determined by the AATCC Test Method 144-1997 (Alkali in Wet Processed Textiles: Total) and less than about 75 ppm formaldehyde as measured by either the JIS L 1041 described herein below.

Determination of Formaldehyde

It has been surprisingly discovered that the formaldehyde which is used to treat fabrics is present in more than one form. The process of the present invention is effective in removing all forms of formaldehyde, inter alia, free CH₂O, paraformaldehyde, and the like.

The following method can be used to measure the level of free formaldehyde on fabric at any point after processing.

Approximately 1-1.5 g of the resin-treated fabric is accurately weighed, cut into small pieces and placed in an Erlenmeyer flask containing 50 mL of ice-cold water. To this are added 1 mL of 2 N sodium sulfite and three or four drops of a thymolphthalein indicator. If the mixture remains colorless, 2 N sodium carbonate is added dropwise until the blue color of the indicator appears. The mixture is neutralized to colorless with 0.3 N hydrochloric acid and is allowed to stand in an ice bath for 7 minutes. Next, 5 mL of ice-cold 1 N acetic acid and a few drops of starch indicator are added. The excess sulfite is titrated with 0.01 n iodine solution. The formaldehyde-bisulfite complex is decomposed with 10 mL of 2 N sodium carbonate, and the liberated sulfite is titrated with 0.01N iodine solution to the blue endpoint of the starch indicator. The free formaldehyde content is calculated as follows:

$$\text{\% Free Formaldehyde} = \frac{\text{(Titer, Iodine) (} \text{N} \text{Iodine) (1.5)}}{\text{(Wt. of Sample, g)}}$$

AATCC Method 112-1978 (Sealed Jar Method) can be used for free and liberated formaldehyde.

One preferred method is the Japanese Immersion Extraction Method, JIS L-1041-1960. In this method approximately 1 g of fabric is accurately weighed, cut into small pieces, and placed in a stoppered Erlenmeyer flask containing 100 mL of distilled water with 0.01% nonionic penetrating agent. The flask is allowed to stand for 1 hour at 25±1° C. with occasional stirring. The fabric is filtered off, and a 50 mL portion of filtrate is transferred to a beaker. To this is added 0.3 mL of a phloroglucinol solution (1% in 2.5 N sodium hydroxide). The absorbance is measured in 10-30 minutes at 460 nm. The formaldehyde content is determined from a previously made calibration curve and calculated as follows:

$$\text{\% Free Formaldehyde} = \frac{\text{(} \text{C} \text{) (} \text{F} \text{) (100)}}{\text{(Wt. of Sample, g)}}$$

where C is the concentration of formaldehyde (in μg/mL) from the calibration curve, F is a dilution factor and W is the sample weight.

Another preferred method is the Japanese Immersion Extraction Method, Japanese Law 112-1973. The fabric sample is cut into small pieces and approximately 1 g is accurately weighed into a 200 mL stoppered Erlenmeyer flask containing exactly 100 mL of distilled water. The tightly closed flask is immersed in a water bath at 40° C. for 1 hour with occasional swirling. The contents of the flask are filtered through a glass filter and the filtrate is retained for analysis.

A 5 mL aliquot is taken of distilled water, filtrate and a standard solution containing 4 μg/mL formaldehyde; each is mixed in a test tube with 5 mL of an acetylacetone solution (150 g of ammonium acetate, 3 mL of glacial acetic acid, and 2 mL of acetylacetone in 1 liter of water). The tubes are capped and immersed in a water bath at 40° C. for 30 minutes. After cooling for 30 minutes, the absorbances of the sample (A) and the standard (As) are measured at 412-415 nm against the reagent blank. As a further control, 5 mL aliquots of distilled water and the sample are each mixed with 5 mL of distilled water and treated as above. The absorbance of the sample (Aₒ) is measured at 412-415 nm against that of the water blank. The formaldehyde content is calculated by the following equation:

$$\text{μg/g Formaldehyde} = \frac{( K ) ( A - {A}_{o} ) ( 100 )}{( {A}_{s} ) ( Wt . of Sample , g )}$$

where K is the concentration of the standard formaldehyde solution.

What is claimed is:

1. A process for providing improved whiteness to cellulosic fabric comprising the steps of:
a) contacting cellulosic fabric with first a composition comprising:
i) from about 0.05% to about 2% by weight, of hydrogen peroxide or a source of hydrogen peroxide;
ii) from 0.01% to about 10% by weight, of a source of alkalinity;
iii) from about 0.001% to about 2% by weight, of a bleach stabilizer; and
iv) the balance carriers and other adjunct ingredients:
wherein the composition has a pH of from about 7 to about 12; at a temperature from about 50° C. to about 80° C. for a period of time from about 5 minutes to about 60 minutes to form a treated fabric; and
b) rinsing the treated fabric with a second composition comprising:
i) water; and
ii) optionally rinse aids and other adjunct ingredients;
to provide a finished fabric.

2. The process of claim 1 wherein the first composition comprises from about 0.1% to about 1% by weight, of hydrogen peroxide or a source thereof.

3. The process of claim 2 wherein the first composition comprises from about 0.1% to about 0.5% by weight, of hydrogen peroxide or a source thereof.

4. The process of to claim 1 wherein the source of hydrogen peroxide is selected from the group consisting of perborate, percarbonate, and mixtures thereof.

5. The process of claim 1 wherein the source of alkalinity is a base selected from the group consisting of alkali metal, alkali earth metal, ammonium, and alkyl ammonium hydroxides, hydrogen carbonates, carbonates, phosphates, hydrogen phosphates, dihydrogen phosphates, and mixtures thereof.

6. The process of claim 5 wherein the source of alkalinity is sodium hydrogen carbonate, sodium carbonate, sodium hydroxide, or mixtures thereof.

7. The process of claim 1 wherein the bleach stabilizer is sodium silicate.

8. The process of claim 1 wherein the bleach stabilizer is selected from the group consisting of hydroxycarboxylates, amino carboxylates, organophosphonates, and mixtures thereof.

9. The process of claim 8 wherein the hydroxycarboxylate stabilizer is gluconic acid, glucoheptonic acid, or mixtures thereof.

10. The process of claim 8 wherein the amino carboxylate stabilizer is nitrilotriacetic acid, ethylenediaminetetraacetic acid, diethylenetriaminepentaacetic acid, or mixtures thereof.

11. The process of claim 8 wherein the organophosphonates stabilizer is aminotri (methylenephosphonic acid), 1-hydroxethylidene-1,1-diphosphonic acid, ethylenediaminetetra (methylenephosphonic acid), diethylenetriaminepenta (methylenephosphonic acid), and mixtures thereof.

12. The process of claim 1 wherein the composition of step (a) comprises one or more optical brighteners selected from the group consisting of bis(triazinyl)stilbenes, nonionic distyrl-arenes, 1,3-diphenyl-2-pyrazolines, naphthalimides, coumarins, bis(benzoxazoles), cationic azoles, and mixtures thereof.

13. The process of claim 1 wherein step (a) is conducted at a temperature of from about 60° C. to about 65° C.

14. The process of claim 1 wherein step (a) is conducted for a period of time from about 15 minutes to about 25 minutes.

15. The process of claim 1 wherein step (a) is conducted at a pH of from about 8 to about 9.

16. A process for providing improved whiteness to cellulosic fabric which has been treated in a previous step with formaldehyde, the process comprising the steps of:
a) contacting cellulosic fabric exposed to formaldehyde with a first composition comprising:
i) from about 0.05% to about 0.5% by weight, of hydrogen peroxide or a source of hydrogen peroxide;
ii) from 0.01% to about 10% by weight, of a source of alkalinity;
iii) from about 0.001% to about 0.5% by weight, of a bleach stabilizer; and
iv) the balance carriers and other adjunct ingredients:
wherein the composition has a pH of from about 7 to about 12; at a temperature from about 50° C. to about 80° C. for a period of time from about 5 minutes to about 60 minutes to form a treated fabric; and
b) rinsing the treated fabric with a second composition comprising:
i) water; and
ii) optionally rinse aids and other adjunct ingredients;
to provide a finished fabric having less than 75 ppm residual formaldehyde.

17. A process for providing improved whiteness to cellulosic fabric comprising the steps of:
a) contacting cellulosic fabric with a first composition comprising:
i) from about 0.05% to about 0.5% by weight, of hydrogen peroxide or a source of hydrogen peroxide;
ii) from 0.01% to about 10% by weight, of a source of alkalinity selected from sodium hydrogen carbonate, sodium carbonate, or mixtures thereof;
iii) from about 0.001% to about 0.5% by weight, of a sodium silicate;
iv) from about 0.01% to about 3% by weight, of an optical brightener; and
v) the balance carriers and other adjunct ingredients:
wherein the composition has a pH of from about 7 to about 12; at a temperature from about 50° C. to about 80° C. for a period of time from about 5 minutes to about 60 minutes to form a treated fabric; and
b) rinsing the treated fabric with a second comprising:
i) water; and
ii) optionally rinse aids and other adjunct ingredients.

18. A process for providing improved whiteness to cellulosic fabric comprising the steps of:
a) contacting fabric which contains formaldehyde with a roller or a pad which delivers onto the fabric a composition comprising:
i) from about 0.05% to about 0.5% by weight, of hydrogen peroxide or a source of hydrogen peroxide;
ii) from 0.01% to about 10% by weight, of a source of alkalinity selected from sodium hydrogen carbonate, sodium carbonate, or mixtures thereof;
iii) from about 0.001% to about 0.5% by weight, of a sodium silicate;
iv) from about 0.01% to about 3% by weight, of an optical brightener; and
v) the balance carriers and other adjunct ingredients:
wherein the composition has a pH of from about 7 to about 12; at a temperature from about 50° C. to about 80° C. for a period of time from about 5 minutes to about 60 minutes to form a treated fabric; and
b) exposing the alkaline treated fabric to an atmospheric steam chamber to produce a treated fabric, said fabric having less than about 75 ppm formaldehyde.

19. The process of claim 18 wherein the atmospheric steam chamber is at a temperature of from about 90° C. to about 100° C.

20. The process of claim 18 wherein the composition a pH of from about 8 to about 9.

21. The process of claim 18 wherein the composition comprises about 10% by weight of sodium hydrogen carbonate.

22. The process of claim 18 wherein the alkaline treated fabric is exposed to the steam chamber for about 5 minutes.
